(19) United States
(12) Patent Application Publication
(10) Pub. No.: US 2018/0129378 A1
(43) Pub. Date: May 10, 2018

(54) ENHANCED TOOLS TO PRESENT AND COLLECT USER INFORMATION FROM COMPUTING DEVICE SCREENS

(71) Applicant: AutoGraph, Inc., Seattle, WA (US)

(72) Inventors: Brian Roundtree, Seattle, WA (US); Kevin Allan, Seattle, WA (US)

(21) Appl. No.: 15/805,689

(22) Filed: Nov. 7, 2017

Related U.S. Application Data
(60) Provisional application No. 62/418,743, filed on Nov. 7, 2016.

(51) Int. Cl. G06F 3/0482; G06F 3/0488; G06F 3/0481

(52) U.S. Cl. CPC G06F 3/0482; H04L 67/306; G06F 3/04817; G06F 3/04883

(57) ABSTRACT

The disclosed tools include enhanced and flexible tools to collect user affinities and other user data.

### RELATED APPLICATION(S)

This application claims the benefit of and priority to the following U.S. Provisional Patent Application No. 62/418,743 filed Nov. 7, 2016, which is incorporated herein by reference in its entirety.

The following previously filed applications are herein incorporated by reference:

U.S. Provisional Patent Application No. 61/493,965

U.S. Provisional Patent Application No. 61/533,049

U.S. Provisional Patent Application No. 61/506,601

U.S. Provisional Patent Application No. 61/567,594

U.S. Provisional Patent Application No. 61/597,136

U.S. Provisional Patent Application No. 61/603,216

U.S. Provisional Patent Application No. 61/683,678

U.S. Provisional Patent Application No. 61/724,863

U.S. Provisional Patent Application No. 61/824,353

U.S. Provisional Patent Application No. 61/972,193

U.S. Provisional Patent Application No. 62/387,277

CONSUMER DRIVEN ADVERTISING SYSTEM, U.S. patent application Ser. No. 13/490,444 filed Jun. 6, 2012

SYSTEM AND METHOD FOR DELIVERING ADS TO PERSONAS BASED ON DETERMINED USER CHARACTERISTICS, U.S. patent application Ser. No. 13/490,449 filed Jun. 6, 2012.

METHOD AND APPARATUS FOR DISPLAYING ADS DIRECTED TO PERSONAS HAVING ASSOCIATED CHARACTERISTICS, U.S. patent application Ser. No. 13/490,447 filed Jun. 6, 2012.

CONSUMER DRIVEN ADVERTISING SYSTEM, International Patent Application No. PCT/US12/41178 filed Jun. 6, 2012.

CONSUMER SELF-PROFILING GUI, ANALYSIS AND RAPID INFORMATION PRESENTATION TOOLS filed Dec. 6, 2012, U.S. patent application Ser. No. 13/707,581.

CONSUMER SELF-PROFILING GUI, ANALYSIS AND RAPID INFORMATION PRESENTATION TOOLS filed Dec. 6, 2012, U.S. patent application Ser. No. 13/707,578.

CONSUMER SELF-PROFILING GUI, ANALYSIS AND RAPID INFORMATION PRESENTATION TOOLS filed Dec. 6, 2012, PCT Application No. PCT/US12/68319.

AD BLOCKING TOOLS FOR INTEREST-GRAPH DRIVEN PERSONALIZATION, U.S. patent application Ser. No. 13/843,635 filed Mar. 15, 2013.

REVERSE BRAND SORTING TOOLS FOR INTEREST-GRAPH DRIVEN PERSONALIZATION, U.S. patent application Ser. No. 13/843,270 filed Mar. 15, 2013.

TOOLS FOR INTEREST GRAPH-DRIVEN PERSONALIZATION, PCT Patent Application No. PCT/US13/32643 filed Mar. 15, 2013.

SELF-TARGETING ADVERTISING DATA COLLECTION AND PROCESSING TOOLS, U.S. patent application Ser. No. 14/078,515 (US) filed Nov. 12, 2013.

SELF-TARGETING ADVERTISING DATA COLLECTION AND PROCESSING TOOLS, PCT Patent Application No. PCT/US2013/69766 (PCT) filed Nov. 12, 2013.

PRIVACY SENSITIVE PERSONA MANAGEMENT TOOLS, PCT Patent Application No. PCT/US14/38502 filed May 16, 2014.

PRIVACY SENSITIVE PERSONA MANAGEMENT TOOLS, U.S. patent application Ser. No. 14/280,480 filed May 16, 2014.

CONSUMER SELF-PROFILING GUI, ANALYSIS AND RAPID INFORMATION PRESENTATION TOOLS, U.S. patent application Ser. No. 14/460,319 filed Aug. 14, 2014.

BEACON BASED PRIVACY CENTRIC NETWORK COMMUNICATION, SHARING, RELEVANCY TOOLS AND OTHER TOOLS, U.S. patent application Ser. No. 14/672,007 filed Mar. 27, 2015.

BEACON BASED PRIVACY CENTRIC NETWORK COMMUNICATION, SHARING, RELEVANCY TOOLS AND OTHER TOOLS PCT Patent Application No. PCT/US2015/23191 filed Mar. 27, 2015.

PRIVACY SENSITIVE PERSONA MANAGEMENT TOOLS, U.S. patent application Ser. No. 15/146,860 filed May 4, 2016.

CONSUMER AND BRAND OWNER DATA MANAGEMENT TOOLS AND CONSUMER PRIVACY TOOLS, U.S. patent application Ser. No. 15/171,997 filed Jun. 2, 2016.

CONSUMER AND BRAND OWNER DATA MANAGEMENT TOOLS AND CONSUMER PRIVACY TOOLS, PCT Patent Application No. PCT/US2016/035576 filed Jun. 2, 2016.

SENSOR BASED PRIVACY CENTRIC NETWORK COMMUNICATIONS, SHARING, RANKING TOOLS AND OTHER TOOLS, U.S. patent application Ser. No. 15/389,226 filed Dec. 22, 2016.

Appendices

Appendix A has a description of technologies described in the incorporated applications.

The technology in these applications as well as the current application are interoperable.

### BACKGROUND

Human physiology presents unique challenges to presenting and collecting large amounts of information. Specifically, human eyes and accompanying body parts can only physically accommodate the viewing of a finite amount of screen space, which limits information presentation and collection of user information pertaining to the presented information. This is especially true when humans interact with mobile device screens and other portable devices with relatively small screens.

Specifically, what is needed are tools to efficiently use limited screen space in a way to enhance the amount of information a user can view and input information.

### BRIEF DESCRIPTION OF THE DRAWINGS

FIG. 1 illustrates one embodiment of a representative user interface screen displaying brand icons to a user;

FIG. 2 further illustrates the embodiment illustrated in FIG. 1;

FIG. 3 illustrates an embodiment in which a plurality of brand icons can be the subject of user input;

FIGS. 4-6 Intentionally Left Blank;

FIG. 7 illustrates an example of computing a persona as discussed in the related patent applications;

FIG. 8 illustrates an embodiment of efficiently gathering granular user information from a user device once the brands are presented to the user;

FIG. 9 illustrates an exemplary user input menu used to input user opinions on a brand; and

FIG. 10 illustrates that the screens in FIGS. 1-3 can be displayed on a screen, which is scrollable to show more additional icons.

### DETAILED DESCRIPTION

Overview—Enhanced Tools to Present and Collect User Information from Computing Device Screens

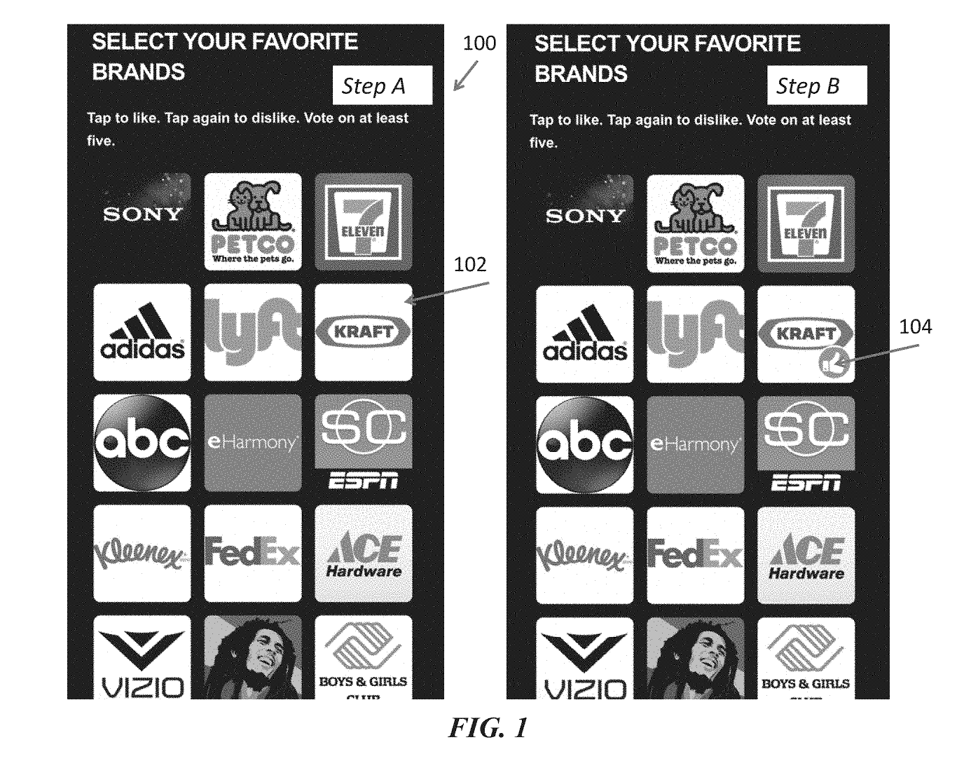

In some of the embodiments described in the applications that are incorporated by reference above, a user provides information about themselves or person that may represent the user by moving tiles representing brand icons on a screen. One portion of the screen is associated with positive associations with the brand (e.g. the user likes the brand) while another portion of the screen is associated with negative associations with the brand (e.g. the user doesn't like the brand or does not shop at the store, buy the goods etc.) While this user interface works well, the disclosed technology allows a user to input information about a number of brands without moving the tiles. As shown in FIG. 1, a screen on a user device (phone, tablet, iPad, slate computer or the like) displays a number of tiles showing brand icons 102 in a grid or other pattern. The user device includes a processor having a memory associated therewith containing instructions that are executable to allow the user to detect the user's opinion of one or more of the brand icons displayed. In one embodiment the processor is configured to execute instructions to detect if the user likes or dislikes a brand by detecting if the user taps on the brand icon. For example, one tap may indicate the user likes the brand and two taps indicates the user doesn't like the brand. Other gestures could also be used. For example, a swipe in one direction across an icon may indicate the user likes the brand and a swipe in another direction (or even in the same direction as the previous swipe) indicates the user doesn't like the brand. The processor of the user device is programmed to detect the gesture and display an indicator reflective of the user's opinion for that brand (e.g. thumbs up for like, thumbs down for dislike, smiley face for like, frown face for dislike, plus for like, minus for dislike etc.) If the user sees an error in the opinion recorded, the user can re-enter the gesture.

Still other embodiments are possible, for example the user may indicate they like the brand by touching a particular area of the brand icon tile (e.g. upper right corner=like, lower left corner=dislike) or an area substantially around the icon tile such as within half a brand icon's distance from a brand icon tile. In another embodiment, selecting a brand icon tile causes the processor to display a pop-up graphic with a sliding scale or some other opinion selector that the user manipulates to indicate their opinion. Once the processor detects the user's input on the selector, the processor removes the pop-up graphic selector and displays the brand icon tile with the indication of whether the user likes or dislikes the brand.

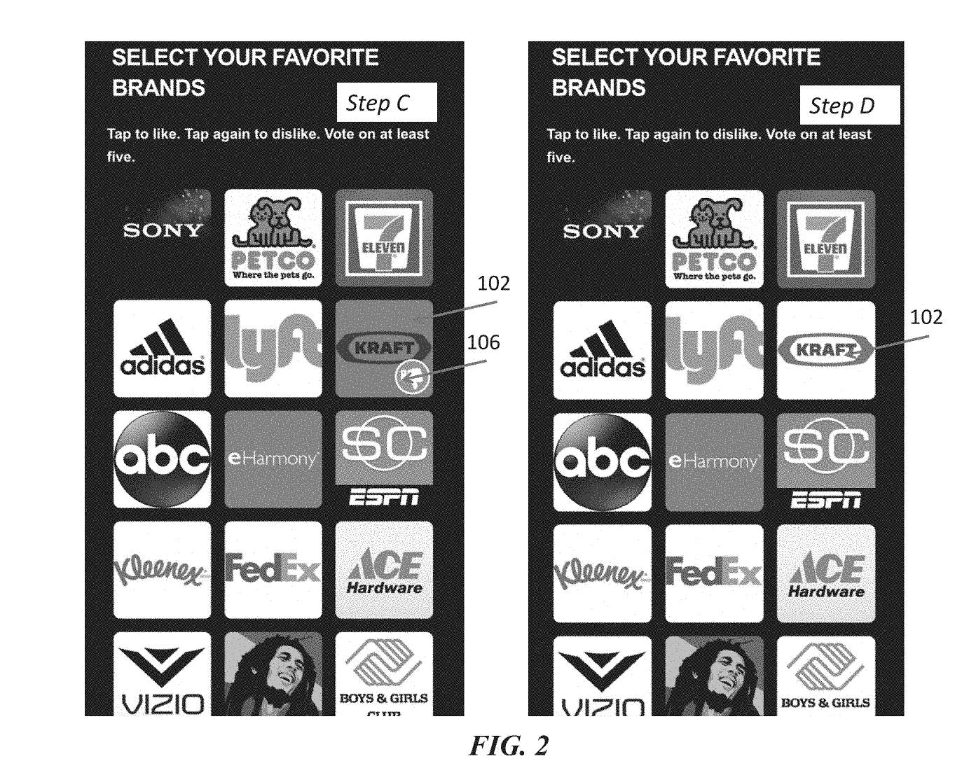

In one embodiment shown in FIGS. 1 and 2, likely demographics about the user or their person are determined from the brands selected and whether the user likes or dislikes the brands. As described in Appendix A, each of the brand icons may be associated with a number of tag values each representing some demographic characteristic. For example, tag 1 may represent how likely the user is to be male and tag 2 indicates how likely the user is to buy guns. If the user likes brand icons such as the magazines “Sports Afield” and “Guns and Ammo” the tag values associated with these brands can be added to provide a composite score of how likely it is that the user has these traits. A fuller explanation of the tag values is described below.

The graphic user interface shown in FIGS. 1, 2, 3 and 10 allow the user to both see multiple brands in a limited area and to indicate their opinion of a brand without having to move the tiles showing the brand icons to different locations on the screen.

After the user has provided their opinion of a minimum number of brands, the processor in the user device executes programmed instructions to send the information received to a remote server that compiles information about the user or their persona. In one embodiment, the processor can send the like/dislike information (e.g. Seven Eleven—like, Kraft—like, Fed Ex—dislike) to the server. Such information could include the brand names or alternatively codes representing the brands or codes indicating the position on the screen/user opinions that was selected by the user could be sent (e.g. brand icon tile at screen position 2,3=like etc.)

In another embodiment, the processor may execute programmed instructions to processes the tag values associated with the brands and transmit the updated tag values after the user has provided information on the number of brands (e.g. tag 1—4.5, tag 2—2.5 etc.)

The tag values representing the likely user/persona demographics can be used by the server computer to deliver advertising that may appeal to the user or to prevent advertising to be delivered that will likely not appeal to the user. Other uses of the tag values are also possible to customize information delivered to the user or their person based on their determined likely demographics.

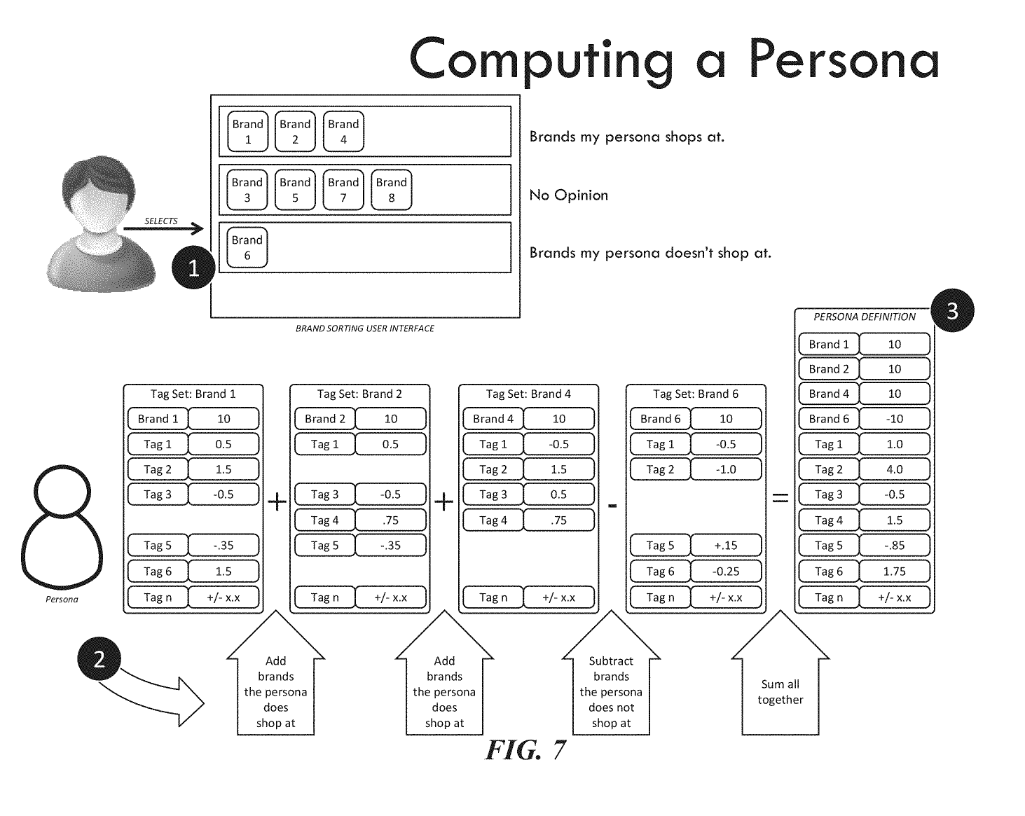

The disclosed tools pertain to the creation and leverage of user profiles. FIG. 7 in the Appendix illustrates an embodiment discussed in the above referenced provisional and utility applications, which demonstrates the creation of a persona/profile from sorting brands on a display screen. This is shown in step 1 in FIG. 7. The disclosed tools pertain to additional tools that may be used in place of or with step 1 in FIG. 7 to facilitate the profile creation illustrated in steps 2 and 3 in FIG. 7.

Specifically, the disclosed tools present the brands represented as brand icons on a computing device screen via a compact and efficient presentation toolset. In addition, the toolset permits collection of granular information from the brand icons using the compact presentation in a way which makes collection of user input more efficient.

FIG. 1 illustrates an embodiment of the above tools. System 100 illustrates a user iPhone or other computing device screen. In this embodiment, the user device receives brands/brand references/brand icons from a server similar to that of step 1 in FIG. 7 as discussed in the above referenced applications. The user device is configured to connect to a remote server and display brands (e.g., show brands as icons). This may be accomplished via HTML 5 or via a mobile device application downloaded via iTunes™. The brands may be preloaded in a downloaded application on the user device or the brands may be downloaded from a remote server upon the user device connecting to the server.

The brands may be arranged in a variety of ways. To utilize the most efficient way of using screen space, the brand icons may be displayed in a grid as shown in FIG. 1. Other arrangements may be used as well. The brand icons are ideally displayed in a size/resolution that is still substantially recognize able to a user consider the user device screen resolution yet displays as many brand icons in the particular device's displays screen.

Collecting Granular Information from User Input

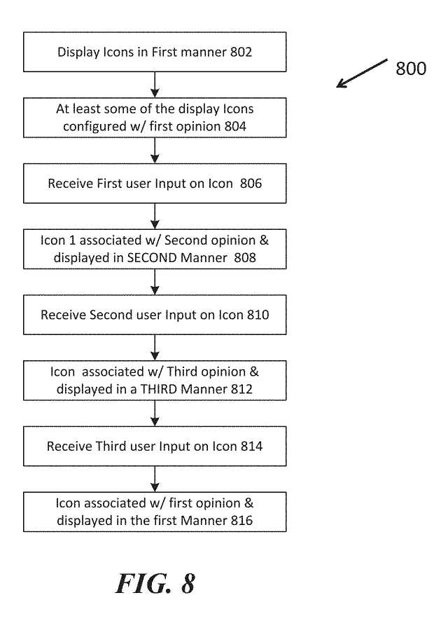

FIG. 8 illustrates steps 800, which are exemplary steps of some of the tools disclosed which efficiently gather granular user information from a user device once the brands are presented to the user. FIGS. 1, 2, 3 and 10 provide embodiments. At 802, brands such as brands represented by icons, text etc., are displayed to the user on her device like in FIG. 1, step A. Here, the brands may be associated to a user opinion by default/any combinations etc. In this embodiment in a manner similar to that discussed in the above reference applications, any user opinion may be used as well as user affinity/interest/past interaction/reaction or any question/opinion that may be asked to the user. Here when the brands are initially presented to the user, each of the brands in step A are associated to a “neutral opinion” at 804. This may be implemented by associating a brand reference corresponding to the brand that icon represents (e.g., a brand ID value) to an opinion tag such as a “neutral opinion” tag or any other type of tag. In one embodiment, the brands initially shown to the user in Step A may be associated by default to the same (e.g., all neutral) or different opinion tags as configured by the server when the user is initially presented with the brands.

A neutral opinion may be displayed by displaying the icons in a first manner such as without indicia or and unaltered.

In one embodiment, the brand references associated to neutral opinion tags may also have this association transmitted to a server for profile building such as in FIG. 7. Alternately, the brand references associated to neutral opinion tags may not be transmitted to the server for profiling building. In turn, the server which typically is aware of which brands were sent to the user can deduce which brands were neutral to the user. In one embodiment, brand references with neutral opinion tags or deduced as natural to the user may not be used in building/determining/calculating the user profile.

At 806, the user's device receives the first user input on an icon. This may be a brand icon such as the Kraft™ brand logo icon 102 in step A in FIG. 1 which receives a first user input.

The user input may comprise types of user input such as a tap on a touch screen, a touch screen gesture, swipe, mouse/finger gesture, keyboard input, a mouse/track pad click, speech, body part input or any other user input on the brand icon itself or substantially near the brand icon or a button displayed to the user on the screen. In one embodiment, a keyboard or button on the screen may be used once a brand e.g., a brand icon is selected and input entered. In another embodiment, any combination of any of the disclosed ways of user input may be used when a user enters multiple inputs on an icon such as a first input on icon 102 as a tap, then a second input on icon 102 as a mouse click etc.

In response to the first user input entered at 806, the user opinion tag associated (or which will be associated) to the brand icon that receives the input is changed (or initially assigned if no opinion tag was previously assigned) to another user opinion tag. For instance, the neutral default user opinion tag is changed to a positive, negative, like, not like, have interacted with, have not interacted with tag or any other tag. In this embodiment, this first user input will change the opinion tag the icon was previously associated with to a “positive” icon. In an optional step, in further response to receiving the first user input, the display or the icon and/or indicia 104 substantially around or on top of the icon is changed e.g., a thumbs up is displayed on the icon such as in FIG. 1 Step B. These steps occur at 808. The icon 102 may be displayed differently by displaying an alpha layer above it e.g., in a range of 50%-90% alpha layer or any other range which visually differentiates the original icon to the user, displaying only parts of the icon, change the size of the icon, changing the orientation of the icon, changing the colors of the icon etc.

In response to the first user input above, the user device may transmit the brand/reference to the brand and the associated opinion tag to a remote server for profile building (e.g., like that of FIG. 7) in response to each user input on the brand icon. This may occur typically in an HTML 5 embodiment. In another embodiment, the user device may transmit brand references and associated opinion tags all at once after a threshold number of brands receive user input or upon a separate command such as the user clicking on a “done” button on the screen. This may occur typically in a mobile application embodiment such as an iPhone application from the iTunes store.

At 810, the user may then input a second input on the same icon discussed above such as icon 102. In response to the input of the second input, the opinion tag associated to the brand icon may be changed to an opinion tag different than the previous two assigned to the brand such as a “negative” opinion tag. Similar to the “positive” tag discussed above, in response to the second input, the brand reference and “negative” opinion tag may be transmitted to the server for profile building or a plurality of brand references and associated opinion tags after each user input or all sent at once.

Optionally, in response to the input of the second input, the appearance of icon 102 may be changed and/or indicia displayed (like in FIG. 1 step B) substantially around or on top of the icon 102 like in step C in FIG. 2. Illustrated in step C is indicia 106 of a thumbs down corresponding to the user's opinion. The above are illustrated at 812. Like the above steps, this may be communicated to a remote server.

At 814, the user enters a third user input on icon 102. The third user input causes the reference to the brand to be associated back with the first opinion and optionally, the icon 102 is displayed like that in 804 in the same manner as it was initially displayed when first presented to the user. This is illustrated at 816 and at step D in FIG. 2. Like the above steps, this may be communicated to a remote server.

In other words, a number of inputs, cycles through associating different opinion tags to the icon 102 and optionally changes the appearance/indicia in a corresponding manner. This simplified user input toolset allows various different user inputs on a brand icon using a minimum of screen space for user interaction.

The embodiment in FIG. 8 may repeat as many times as desired.

Thus, the brand reference to icon 102 could be associated to any number of opinion tags and optionally the appearance/indicia could change to reflect the different opinions. This cycling between opinion tags and optionally corresponding appearance changes can restart after the last opinion tag is assigned to the reference to the brand in the same order as the first cycle. Alternately, during the same cycle, the order the brand opinion tags are assigned to a given brand icon and the optional corresponding display/indicia properties can happen randomly or other order as desired.

In one example, the user inputs would first cycle through the various opinion tags and associate them to the reference to the brand icon in 5 different user opinions such as really like, like, neutral, hate, really hate starting back over to really like. Once, the first cycle is completed and restarts by the input of additional “taps” or other inputs on the brand icon, the cycle can start identically e.g., really like, like, neutral, hate, really hate in response to additional user inputs. A variation of this cycle is illustrated in FIGS. 1-2 using neutral, thumbs up, thumbs down back to neutral with three different user opinions. Any number of user opinions can be used and recycled as above such as between just neutral and positive opinions.

### Other Embodiments

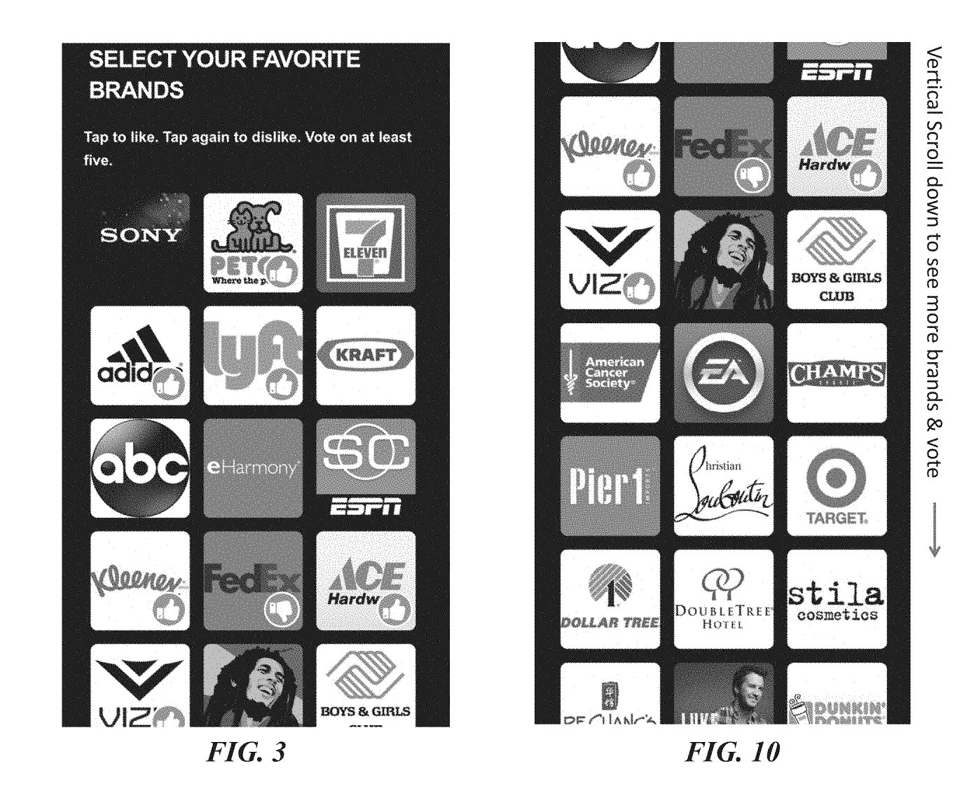

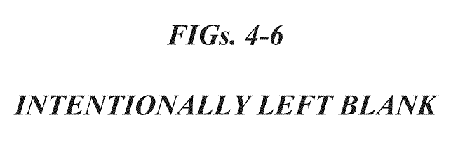

FIG. 3 illustrates an embodiment in which a plurality of brand icons can each be the subject of user input like above.

FIG. 10 illustrates that the screens in FIGS. 1-3 can be displayed on a screen, which is scrollable to show more additional icons.

### Menu Use Embodiments

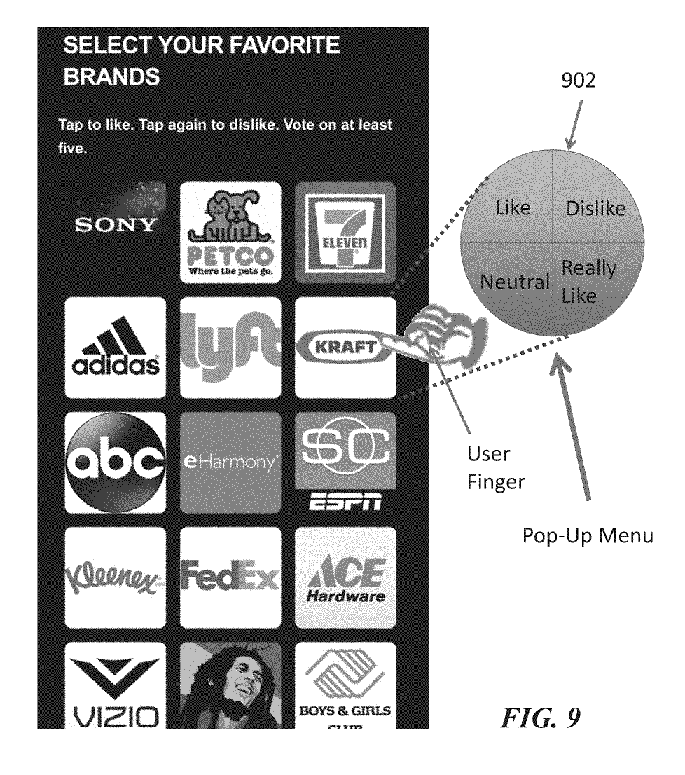

FIG. 9 illustrates an exemplary user input menu used to input user opinions on a brand. This may include a pop-up menu 902. An indication reflecting the type of user opinion tag that may be input by the user may be displayed in the menu. The menu may display any number of said indications such as like, dislike, neutral, really like etc., as well as commands like share, copy, paste, SMS etc. The menu may be displayed upon user input such as by a finger or mouse input. In one embodiment, a user tap or touch and hold input (or hold with more physical downward force on a display screen than other downward inputs on the display screen) or mouse hover input displayed the menu. The user may then continue holding the user input and drag her finger on top of the desired indication in the menu. Alternately, the user may cease the input once the menu is displayed and then select the desired input by user tap or other input.

In other menu embodiments, the user may slide or swipe the brand icon in a direction to reveal a menu displaying the above indications.

Appendix A

Appendix A has text previously disclosed in the above referenced applications discussing FIG. 7 e.g., the creation of a profile after step 1 in FIG. 7 and the illustrated characteristic (e.g., tags) and associated characteristic statistical probabilities which represent a likelihood of a user having the characteristic and the use of user opinions in determining the characteristic statistical probabilities.

In one embodiment of the disclosed technology, the tags for the brands represent the same demographic characteristic. For example, Tag 1 for all the brands may represent the likelihood that the user is a male between ages 25-40, while Tag 2 may represent the likelihood that the user is a male between ages 40-55. Tag 3 may represent the likelihood that the user is a woman between ages 18-22 etc. Each tag has or is associated with a value representing the likelihood of a user having a defined demographic characteristic. These values for the tags are typically determined from information gathered from consumers who volunteer information about themselves and what brands they like, purchase etc. Such information is typically gathered from marketing data from consumer surveys or a variety of other data sources. The details of associating consumer demographic information with particular brands are considered to be well known to those skilled in marketing. In other embodiments, users may assign a value to a brand by inputting the value itself into the computing device, assigning a relative value to each brand and or tag (brand X given a higher preference to brand Y by giving brand X a location assignment a screen above or to the right of brand Y) etc.

Not every brand may have the same set of tags associated with it. For example Brand 1 does not have a Tag 4, while Brand 2 does not have Tags 2 and 6 and Brand 6 is lacking Tags 3 and 4.

In one embodiment, the composite demographic characteristics for a persona are created by arithmetically combining the values of the tags for the liked and disliked brands. In the example shown, Brands 1, 2 and 4 are liked so their tag values are summed while Brand 6 is disliked so its tag values are subtracted. When combined as illustrated, Tag 2 has a summed value of 4.0 (1.5 plus 1.5 minus (−1.0)). A value of 4.0 for a tag may represent a strong likelihood that a user has the demographic characteristic defined by the tag. On the other hand, a tag with a combined value of −2.5 may provide an indication that the user probably does not have the demographic characteristic associated with the tag and an inference can then be made. For example, if a composite gender tag value suggests the user is likely not a male, an inference can be made that the user is a likely female. A composite of the values of the brand tags across the brands (e.g., the sum of statistical probabilities of tag A across brands X to Y as seen in FIG. 7) may also be represented by a vector that is associated with the persona. Each brand tag value in FIG. 7 may be a dimension of the vector.

1. A processor-based system, comprising:
a. a touch screen;
b. memory for storing instructions that are executable by processor electronics;
c. processor electronics configured to execute the instructions in order to:
i. display a plurality of images in a grid layout to a user on the touch screen, wherein the plurality of images comprise a first image which is associated to first opinion tag;
ii. receive a first tap input on the first image;
iii. in response to the first tap input, associate a second user opinion tag to the first image;
iv. receive a second tap input on the first image;
v. in response to the second first tap input, associate a third user opinion tag to the first image;
vi. receive a third tap input on the first image;
vii. in response to the third tap input, associate a fourth user opinion tag to the first image;
viii. transmit the image and the associated fourth user opinion tag to a profile on a remote server; and
ix. receive content from the remote server in which the content transmitted to the system was selected based on the profile.
